(19) United States
(12) Patent Application Publication
(10) Pub. No.: US 2012/0182625 A1
(43) Pub. Date: Jul. 19, 2012

(54) Optical Element

(76) Inventor: Tsutomu Shimizu, Misato-shi (JP)

(21) Appl. No.: 13/498,507

(22) PCT Filed: Aug. 23, 2010
(86) PCT No.: PCT/JP2010/064156

§ 371 Date: Mar. 27, 2012

(30) Foreign Application Priority Data
Sep. 30, 2009 (JP) 2009-226675

(51) Int. Cl. G02B 3/00

(52) U.S. Cl. 359/642

(57) ABSTRACT

Disclosed is an optical element wherein a fine shape is transferred precisely to the outer edge side of a lens while increase in cycle time is prevented. In the optical element, the outermost periphery of the fine shape is covered with a protrusion section provided at a flange part. Accordingly, in injection molding, with the resin introduced into the molding cavity formed in the mold, the molding cavity section corresponding to the resin inflow port side of the protrusion section provided at the flange part is filled first, and thereafter the molding cavity section corresponding to the fine shape adjacent to the protrusion section is filled. Preheating a mold surface section, for transferring the fine shape, of a movable mold with the resin accumulated in the molding cavity corresponding to the protrusion section suppresses the temperature reduction of the mold surface section corresponding to the fine shape.

### TECHNICAL FIELD

The present invention relates to an optical element which has fine shape in an optical surface, especially an object lens and other optical elements which are included in an optical pickup device.

### BACKGROUND ART

There exists a heat cycle system for injection molding as a production method of an optical element, the system is provided with a temperature sensor near a cavity surface and the system controls the molding temperature of an optical element with a cooling device which sends a coolant to the channel near the cavity and a heating device which uses the heater for heating a coolant (refer to patent literature 1).

Moreover, there exists an optical element made of resin having: an optically functional part provided with fine shape on one side of the optical element fabricated by the movable die; and a flange part around the optically functional part, and the heat contraction prevention part is provided in the flange part, the heat contraction prevention part prevents the heat contraction in a direction perpendicular to a direction of an optical axis (refer to patent literature 2). An internal surface of the flange part, for example, serves as the heat contraction prevention part.

### PRIOR ART DOCUMENT

### Patent Literature

Patent Literature 1: Japanese Unexamined Patent Application Publication No. H6-328538
Patent Literature 2: Japanese Unexamined Patent Application Publication No. 2005-132002

### SUMMARY OF HE INVENTION

### Problems to be Solved by the Invention

In the case of a heat cycle system described in the patent literature 1, transferability can be improved, but since time is spent on heating and cooling of a metallic mold, there is a problem that cycle time increases, productivity falls and manufacture cost increases.

Moreover, when fine shape is prepared in an optically functional part like the patent literature 2, resin becomes difficult to enter into the mold surface portion corresponding to fine structure, and transferability may deteriorate. Among the optical surfaces of a lens, especially the fine shape by the side of an outer edge is provided in the outer perimeter of the bush for transfer. Accordingly, temperature falls easily by heat dissipation, the resin viscosity at the time of filling may rise, and it may become remarkable deteriorating.

Then, this invention aims providing an optical element in which the outer edge side of a lens having the transferred fine shape with high precision, while preventing the increase in the cycle time at the time of manufacture.

### Means for Solving the Problems

To achieve the above-mentioned object, an optical element according to the present invention comprising: an optically functional part provided with a fine shape on an optical surface of the optical element; and a flange part provided on a periphery of the optically functional part, wherein the optical element is formed by injection molding of a resin introduced into a cavity of a molding die through a portion corresponding to an outer peripheral edge of the flange part, wherein the flange part includes a heat insulation keep-warm part which projects in an optical surface side, and the heat insulation keep-warm part covers an outermost circumference of the fine shape provided on the optical surface from outside in a direction perpendicular to an optical axis.

The heat insulation keep-warm part prepared in the flange part covers the outermost circumference of the fine shape prepared in the optical surface from the outside in a direction perpendicular to an optical axis in the above-mentioned optical element. Therefore, the cavity portion corresponding to the resin inlet side among the heat insulation keep-warm part prepared in the flange part is filled up with the resin introduced in the cavity formed in the mold at the time of injection molding at first, and then the cavity portion corresponding to the fine shape which adjoins the heat insulation keep-warm part is filled up with the resin introduced in the cavity. After filling up with the resin, the entire outermost circumference of the fine shape is surrounded by the insulation keep-warm part.

Thus, the temperature fall of the mold surface portion corresponding to this fine shape is controlled by heating beforehand the mold surface portion for transfer of fine shape in the mold with resin collected on the cavity corresponding to a heat insulation keep-warm part. As a result, since the resin introduced into the mold surface portion corresponding to the fine shape where it got warm by preheating among in the mold enters into the concave portion of the fine transfer structure of a mold surface portion easily, the transferability can be improved and it can offer a highly precise optical element.

In a specific aspect of the present invention, the heat insulation keep-warm part is provided circularly along the flange part. In this case, the mold surface portion corresponding to the fine shape of the mold is preheated as a whole by the circular heat insulation keep-warm part.

In another aspect of the present invention, the flange part includes a constricted portion formed in a boundary with the optically functional part, and a ratio of A/B is 0.25 or more and 0.85 or less, where A represents a distance in a direction of the optical axis from a bottom of the constricted portion to a distal end vertex of the fine shape that is covered by the heat insulation keep-warm part and B represents a distance in the direction of the optical axis from the bottom of the constricted portion to a top of the heat insulation keep-warm part.

In this case, by setting the ration A/B to be 0.85 or less, it is possible to cover the mold surface portion corresponding to the entire top portion of the outermost circumference of the fine shape by the melted resin to form the heat insulation keep-warm part with sufficient margin from outside perpendicular to the optical axis. And by setting the ratio A/B to be 0.25 or more, it is not necessary to bring a fine shape position extremely close to a part for a constricted portion. For this reason, the work of machining fine transfer structure on the mold bush corresponding to the optically functional part becomes easy, or it becomes possible to make it hard to damage the top of the mold bush at the time of machining fine transfer shape structure.

In still another aspect of the present invention, C and D satisfy a relationship of C<D, where C represents a distance from a distal end vertex of the outermost circumference of the fine shape that is covered by the heat insulation keep-warm part to a first intersection at which a line extending in a radial direction perpendicular to the optical axis intersects with a bore surface of the heat insulation keep-warm part and D represents a distance from the first intersection to a second intersection at which the line extending in a radial direction perpendicular to the optical axis interests with an outer surface of the heat insulation keep-warm part.

In this case, the fine shape on the optical surface surrounded by the heat insulation warm-keep part is effectively heat insulated from the circumference and concurrently warmed by quantity of heat of the melted resin collected on the portion corresponding to the heat insulation keep-warm part in the cavity of the mold. Thus the transferability is further improved.

In still another aspect of the present invention, D and E satisfy a relationship of E<D, where D represents a distance from a first intersection at which a line extending in a radial direction perpendicular to an optical axis intersects with a bore surface of the heat insulation keep-warm part from a distal end vertex of the fine shape that is covered by the heat insulation keep warm part to a second intersection at which the line interests with an outer surface of the heat insulation keep-warm part and E represents a thickness in a direction of the optical axis of a constricted portion of the flange part formed in a boundary with the optically functional part.

In this case, the melted resin which reached the portion of the fine shape of the optical surface surrounded by the heat insulation keep-warm part is effectively heat insulated from the circumference by the quantity of heat of the melted resin collected on the portion corresponding to the heat insulation keep-warm part in the cavity of the mold. Thus the transferability is further improved.

In still another aspect of the present invention, a ratio E/D is 0.65 or more and 0.85 or less. In this case, because the ratio E/D is 0.85 or less, the melted resin is filled in the cavity of the molding die corresponding to the heat insulation keep-warm part prior to the cavity of the molding die corresponding to the fine shape. And because the ratio E/D is 0.65 or more, after the cavity of the molding die corresponding to the heat insulation keep-warm part is filled up with the melted resin, the cavity of the molding die corresponding to the fine shape is quickly filled while controlling the tendency in which melted resin carries out cooling solidification and which carries out sealing at the constricted portion.

In still another aspect of the present invention, an angle θ between a bore surface of the heat insulation keep-warm part and an optical axis is 5° or more and 45° or less. By setting the angle θ 5° or more, it is possible to make the resistance at a time of demolding small. And by decreasing the resistance at a time of demolding, inclination of an optical element can be controlled and deformation of the fine shape caused by demolding with inclination can be prevented. And by setting the angle θ 45° or less, it is possible to prevent the distance C from being too long. Thus the optical element can be prevented from having big diameter.

### BRIEF DESCRIPTION OF THE DRAWINGS

FIG. 1 is a partial sectional side elevation view of a lens of an embodiment.

FIG. 2 is a partial sectional side elevation view for explaining a mold for forming a lens shown in FIG. 1.

FIG. 3 is a view for explaining the flow channel space for supplying resin and the cavity for molding a lens.

FIG. 4 is a view for explaining the optical pickup device incorporating the lens of FIG. 1.

### DESCRIPTION OF EMBODIMENTS

Hereafter, the objective lens for optical pickup device which is one embodiment of the optical element relating to the present invention is explained.

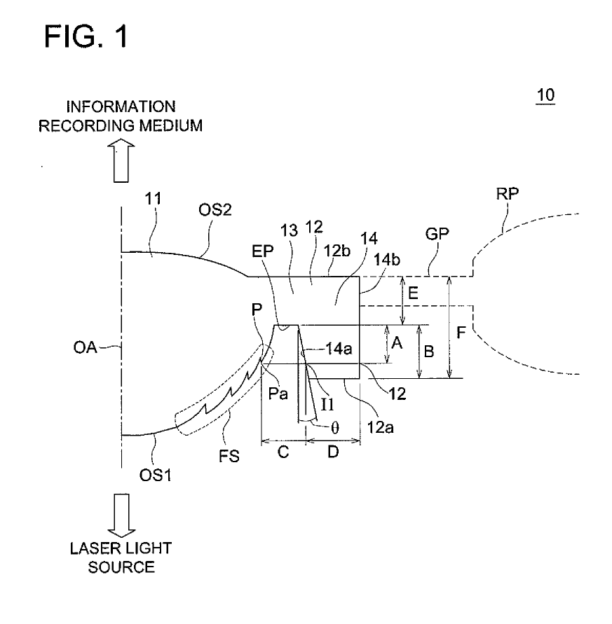

The objective lens 10 shown in FIG. 1 is a product made from a plastic, and is equipped with the circular optically functional part 11 which has an optical function, and the circular flange part 12 prepared in the radial outside from the outer edge of the optically functional part 11. Since the objective lens 10 has a shape symmetrical about the optical axis OA, it is illustrating only the half and is omitting the remaining illustration.

This objective lens 10 is an objective lens having NA of 0.75 or more. Specifically, the objective lens 10 shall be a two-wavelength compatible type single objective lens, for example. In this case, the objective lens 10 enables reading or writing of optical information corresponding to the standard of BD (Blu-Ray Disc) of NA 0.85 on the wavelength of 405 nm, and also enables, for example, reading or the writing of optical information corresponding to one standard of the DVD (Digital Versatile Disc) standard of NA 0.65 on the wavelength of 655 nm and CD standard of NA 0.53 on the wavelength of 780 nm.

The optically functional part 11 of the objective lens 10 has 1st optical surface OS1 having a large convex curvature on the front side, and has 2nd optical surface OS2 slightly convex on the back side. Among these, when the objective lens 10 is built in the optical pickup device and it operates, the 1st optical surface OS1 is arranged at a side near the laser light source for reading or writing. Moreover, when the objective lens 10 is built in the optical pickup device and it operates, the 2nd optical surface OS2 is arranged so as to oppose BD which is an optical information recording medium. Moreover, the fine shape FS which is diffractive structure is formed in 1st optical surface OS1. This fine shape FS is formed of ring-shaped concentric zones and outermost circumference of the fine shape FS extends to a position near the outer edge of the optically functional part 11. The peak Pa of the projection P of the outermost circumference of the fine shape FS is arranged on a side of the optical recording-medium side with respect to the top surface 12a of the flange part 12 in the direction of optic-axis OA, i.e., 2nd optical surface OS2 side.

The flange part 12 of the objective lens 10 is equipped with the annular constricted portion 13 provided in the boundary with the optically functional part 11 and the annular projection portion 14 provided in the radial outside of the constricted portion 13. The constricted portion 13 provided in the inner side is a relatively thin portion, and the projection portion 14 provided in the outside is a relatively thick portion. The projection portion 14 provided in the outside projects from the constricted portion 13 in the laser light source side, i.e., 1st optical surface OS1, side, and when it carries out injection molding of the objective lens 10, it functions as a heat insulation keeping-warm part which suppresses cooling of the transfer surface of the optically functional part 11. Ring-shaped plane EP is formed on the laser light source side, i.e., 1st optical surface OS1 side of the constricted portion 13.

In addition to the top surface 12a that is perpendicular to the optical axis OA, the projection portion 14 has the bore surface 14a which opposes the fine shape FS of the optically functional part 11 and the outer surface 14b arranged on both sides of the top surface 12a at the opposite side of the bore surface 14a. The bore surface 14a is extended with inclination to the optical axis OA, and it has the tapered shape which spreads in the laser light source side. The outer surface 14b is extended in parallel to optical axis OA, and has cylindrical configuration. In addition, the optical information recording-medium side, i.e., 2nd optical surface OS2 side of the flange part 12 whole is the flat field 12b which extends at right angles to the optical axis OA. This field 12b has a domain which consists of a flat side which carries out mirror reflection of the collimated light, for example, and when aligning the objective lens 10, it is used.

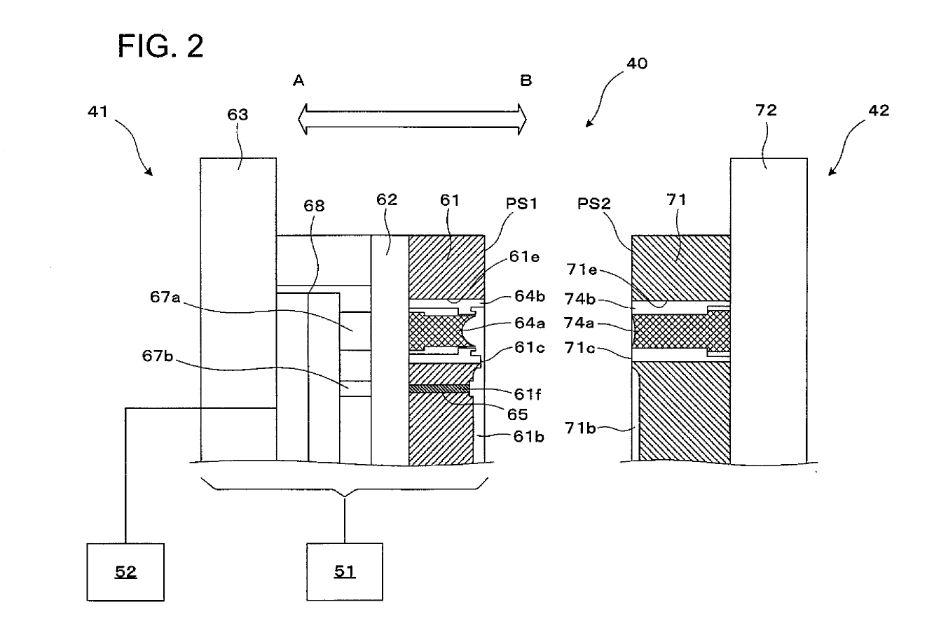

The molding die for manufacturing the objective lens 10 shown in FIG. 1 is hereafter explained with reference to FIG. 2. The molding die 40 of illustration is equipped with the movable mold 41 as the 1st mold, and the fixed mold 42 as the 2nd mold. The movable mold 41 is driven by the mold open/close drive apparatus 51 and can move back-and forth in the AB direction and opening-and-closing operation is attained between the fixed metallic molds 42. By matching the both molds 41 and 42 at parting surfaces PS1 and PS2 and clamping the both molds, the cavity for injection molding can be formed as explained in full detail below.

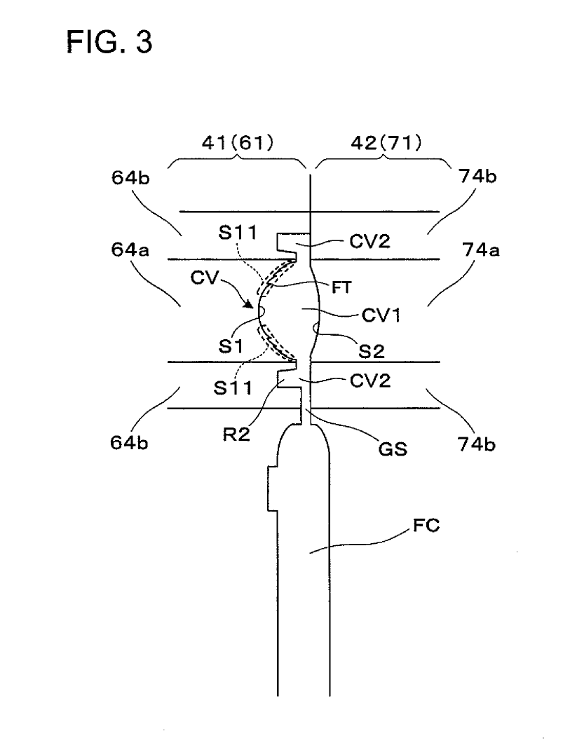

As shown in FIG. 3, the cavity of a molding die CV for fabricating the objective lens 10 and the flow channel space FC for supplying resin to the cavity of a molding die CV are formed by a mold clamp of the movable mold 41 and the fixed mold 42. Among these, the cavity of a molding die CV corresponds to the form of the objective lens 10 shown in FIG. 1. Moreover, the flow channel space FC is the space corresponding to the runner RP of the molded article before separating the objective lens 10, and the gate portion GS is the space corresponding to the gate GP of this molded article. In addition, in the objective lens 10 shown in FIG. 1, the gate portion GS is completely removed by finish machining.

The cavity of a molding die CV includes the main body cavity CV1, and a flange cavity CV2. Here, the 1st transfer surface S1 and the 2nd transfer surface S2 which define the main body cavity CV1 are for forming the 1st optical surface OS1 and the 2nd optical surface OS2 of the central main optically functional part 11 in the objective lens 10, respectively, and they correspond to the edge surfaces of the core dies 64a and 74a mentioned later. In this case, the 1st transfer surface S1 is deeper than the 2nd transfer surface S2 and the curvature of 1st transfer surface S1 is larger than that of the 2nd transfer surface S2. Moreover, the mold surface portion S11 corresponding to the fine shape FS of the objective lens 10 is formed in the 1st transfer surface S1.

Referring back to FIG. 2, the movable mold 41 on a movable side is provided with: the template 61 which forms parting surface PS1; the backup plate 62 which supports the template 61 from behind; the attachment plate 63 which supports the backup plate 62 from behind; the core die 64a as a mold bush which forms the cavity of a molding die CV (especially the main body cavity CV1) shown in FIG. 3; and the outer circumferential die 64b as a peripheral part which forms the cavity of a molding die CV (especially the flange cavity CV2). Furthermore, the movable mold 41 is provided with: the pushing-out pin 65 which projects and pushes out the runner RA of the molded article before separating the objective lens 10; the movable rod 67a which pushes the core die 64a from behind; the movable rod 67b which pushes the pushing-out pin 65 from behind; and the back-and forth member 68 which moves the movable rods 67a and 67b back and forth.

Here, the core die 64a is driven by the advancing movable rod 67a and moves forward to the fixed mold 42 side, and moves back automatically with back away of the movable rod 67a, and returns to the original position. Moreover, the back-and forth member 68 is driven by the back-and-forth drive apparatus—and moves back-and forth in the AB direction with suitable timing and quantity.

In the movable mold 41, the template 61, which is the mold part on the side of mold surface, is provided with: the runner concave portion 61b which forms the runner RP shown in FIG. 1; the gate concave portion 61c which forms the gate GP; and the penetration holes 61e and 61f prepared in order to insert the outer circumferential die 64b and the pushing-out pins 65 and 66.

The fixed mold 42 on the fixing side is provided with: the template 71 for forming the parting surface PS2; fixation forms parting side PS2; the attachment plate 72 for supporting the template 71 from behind; the core die 74a as a mold bush which forms the cavity of a molding die CV (especially the main body cavity CV1) shown in FIG. 3; and the outer circumferential die 74b as a peripheral part which forms the cavity of a molding die CV (especially the flange cavity CV2).

In the movable mold 42, the template 71, which is the mold part on the side of mold surface, is provided with: the runner concave portion 71b which forms the runner RP shown in FIG. 1; the gate concave portion 71c which forms the gate GP; and the penetration hole 761e prepared in order to insert the outer circumferential die 74b.

Hereafter, the conditions about the size of the flange part 12 of the objective lens 10 etc. are explained. First, we think about a relationship between the distance A representing a distance in a direction of the optical axis from the flat surface EP of the bottom of the constricted portion 13 to the peak Pa of the projection P on the outermost of the fine shape FS and the distance B representing a distance in the direction of the optical axis from the flat surface EP of the bottom of the constricted portion 13 to a top surface 12a of the projection portion 14 which corresponds to the top portion of the heat insulation keep-warm part.

In the present embodiment, the ratio A/B is made to be 0.25 or more and 0.85 or less. By setting the ration A/B to be 0.85 or less, it is possible to cover the mold surface portion corresponding to the projection P on the outermost of the fine shape FS among the mold surface S11 by the melted resin for forming the projection portion 14 with sufficient margin from outside perpendicular to the optical axis. Moreover, by setting the ration A/B to be 0.25 or less, it is not necessary to bring the position of the projection P on the outermost of the fine shape FS extremely close to a part for the constricted portion 13.

For this reason, the work which processes the fine transfer structure FT corresponding to the fine shape FS into the mold surface portion S11 of the core die 64a becomes easy, or the tip of the core die 64a can be made hard to be damaged at the time of processing of the fine transfer structure FT corresponding to the fine shape FS.

Nest, we think about a relationship between the distance C representing a distance from the top portion Pa of the projection P on the outermost of the fine shape FS to a first intersection I1 at which a line extending in a radial direction perpendicular to the optical axis OA intersects with a bore surface 14a of the projection portion 14 and the distance D representing a distance from the first intersection I1 to a second intersection I2 at which the line extending in a radial direction perpendicular to the optical axis OA interests with the outer surface 14b of the projection portion 14.

In the present embodiment, these size relationship shall be C<D. With this relationship, on the occasion of injection molding, the melted resin reached the portion of fine shape FS surrounded by the projection portion 14 is effectively insulated from the circumference and concurrently warmed by quantity of heat of the melted resin collected on the recess R2 of the flange cavity CV2 which corresponds to the projection portion 14 of the cavity of a molding die CV. Thus the transferability is further improved.

Next, a relationship between the distance D representing a distance from the first intersection I1 to the second intersection I2 and a thickness E representing a thickness in a direction of the optical axis OA of the constricted portion 13 is considered. In addition, this thickness E is equivalent to what obtained by subtracting the distance B which is the amount of protrusion compared with the constricted portion 13 from the total thickness F of the projection portion 14.

In the present embodiment, these size relationship shall be E<D. With this relationship, on the occasion of injection molding, the melted resin reached the portion of fine shape FS surrounded by the projection portion 14 is effectively insulated from the circumference and concurrently warmed by quantity of heat of the melted resin collected on the recess R2 of the flange cavity CV2 which corresponds to the projection portion 14 of the cavity of a molding die CV. Thus the transferability is further improved.

In the present embodiment, the ratio E/D is made to be 0.65 or more and 0.85 or less. By setting the ration E/D to be 0.85 or less, on the occasion of injection molding, it is possible to fill the recess R2 of the flange cavity CV2 which corresponds to the projection portion 14 with the melted resin ahead of the cavity portion of the molding die corresponding to the fine shape FS among the main body cavity CV1, and the transfer surface S11 is effectively preheated. And by setting the ration E/D to be 0.65 or more, after the recess R2 of the flange cavity CV2 corresponding to the projection portion 14 is filled up with the melted resin, the cavity portion of the molding die corresponding to the fine shape FS among the main body cavity CV1 is quickly filled while controlling the tendency in which melted resin carries out cooling solidification and which carries out sealing at the constricted portion 13.

Next, about the angle θ between the bore surface 14a of the projection portion 14 and the optical axis OA, the angle θ is set to be 5° or more and 45° or less, in the present embodiment. By setting the angle θ is set to be 5° or more, it is possible to make the resistance at a time of demolding the objective lens 10 small. And by decreasing the resistance at a time of demolding inclination of the objective lens 10 can be controlled and deformation of the fine shape FS caused by demolding with inclination can be prevented. And by setting the angle θ 45° or less, it is possible to prevent the distance C from being too long. Thus the objective lens 10 can be prevented from having big diameter.

Hereafter, the production method of the objective lens 10 is explained briefly. First, the movable mold 41 and the fixed mold 42 are suitably heated with a non-illustrated tool temperature regulation machine. Thereby, the temperature of the mold portion which forms the cavity of a molding die CV in both the molds 41 and 42 is changed into the temperature state of being suitable for molding. Next, by operating the mold open/close drive apparatus 51, advancing the movable mold 41 to the fixed mold 42 side to keep the molds in mold closing state, and continuing further closing operation of the mold open/closing drive apparatus 51, the movable mold 41 and the fixed mold 42 are clamped with necessary pressure.

Next, non-illustrated injection equipment is operated to execute an injection of melted resin through the gate portion GS with required pressure into the cavity of a mold die CV between the clamped movable mold 41 and the fixed die 42. Since melted resin in the cavity of a mold die CV is gradually cooled by heat dissipation after introducing melted resin into the cavity of a mold die CV, it waits for melted resin to solidify with this cooling and to complete molding.

Next, the mold open/close drive apparatus 51 is operated, the movable mold 41 is moved backward, and a mold opening operation in which the movable mold 41 is removed from the fixed mold 42 is performed. As a result, the objective lens 10 which is a molded article is demolded from the fixed mold 42 while being carried by the movable mold 41.

Next, the back-and-forth drive apparatus 52 is operated and the objective lens 10 is pushed out by the core die 64a and the pushing-out pin 65 through the movable rods 67a and 67b. As a result, the objective lens 10 is pushed by the movable rod 67a etc., it is pushed out to the fixed mold 42 side, and the objective lens 10 is demolded from the movable mold 41. In addition, the objective lens 10 demolded from the both molds 41 and 42 is carried out to the exterior of the molding equipment by clamping the sprue portion extending from the runner RP. Furthermore, the objective lens 10 after taking out is given outside processing of removal of gate GP etc., and prepared to be a product for shipment.

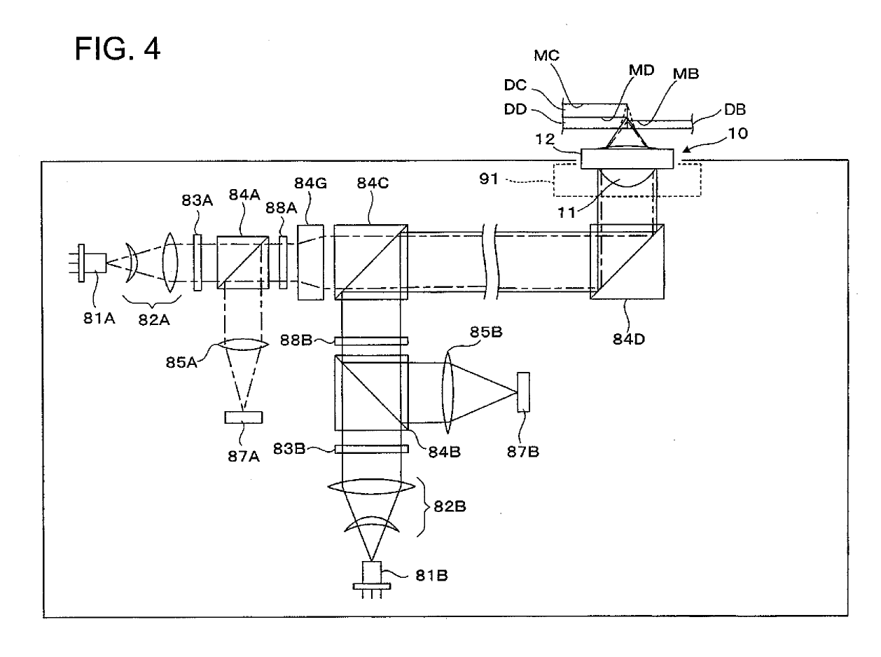

FIG. 4 is a figure showing roughly the construction of the optical system of the optical pickup device incorporating the objective lens 10 of FIG. 1.

In the optical pickup device of illustration, the laser light from each laser diodes 81A and 81B is irradiated to the optical disc DB and DD (or DC) which are optical information recording media using the compatibility type objective lens 10, and, the reflected light from each optical disc DB and DD (or DC) are led to each optical power detectors 87A and 87B through the compatibility type objective lens 10.

In addition to the laser diodes 81A and 81B and the optical power detectors 87A and 87B, the optical system including: the collimator systems 82A and 82B; Grating 83A and 838; the polarization beam splitters 84A and 84B; the beam expander 84G; the servo lenses 85A and 85B; ¼ wavelength plates 88A and 88B; the dichroic prism 84C; the prism mirror 84D; and etc. functions as an optical device for performing recording and reproducing of information to each optical disc DB and DD (DC).

Here, the 1st laser diode 81A generates the laser light for information reproducing of the 1st optical disc DB (specifically wavelength of 405 nm for BD), this laser light is condensed with the objective lens 10, and a light spot equivalent to NA 0.85 is formed on the information recording surface MB. The 2nd laser diode 81B generates the laser light for information reproducing of the 2nd optical disc DD or DC (specifically wavelength of 655 nm for DVD or wavelength of 780 nm for CD), thereafter the laser light is condensed by the objective lens 10, and a light spot equivalent to NA 0.65 (or NA 0.53) is formed on the information recording surface MD (MC).

On the other hand, the 1st optical power detector 87A detects the information recorded on the 1st optical disc DB (specifically BD) as a light signal, and the 2nd optical power detector 87A detects the information recorded on the 2nd optical disc DD or DC (specifically DVD or CD) as a light signal.

Hereafter, a detailed structure of the optical pickup device of FIG. 4 and specific operation are explained. When playing the 1st optical disc DB first, laser light with a wavelength of 405 nm, for example, is emitted from the first laser diode 81A and the emitted light flux turns into a parallel light flux by the collimator system 82A which consists of beam shaper or a collimating lens. This light flux passes through the grating 83A, the polarization beam splitter 84A, ¼ wavelength plate 88A, etc. then passes through the dichroic prism 84C and the prism mirror 84D. Then the light flux is condensed by the objective lens 10 on the information recording surface MB of the 1st optical disc DB.

The light flux which was modulated on the information recording surface MB by the information bit and was reflected, passes through the objective lens 10 again and it enters into the polarization beam splitter 84A through the dichroic prism 84C etc. The light flux is reflected at the dichroic prism 84C and astigmatism is given by the servo lens 85A. The light flux then enters on the 1st optical power detector 87A, and the reading signal of the information recorded on the 1st optical disc DB is acquired using the output signal.

Moreover, focus detection and track detection are performed by detecting the change of the light volume of the spot on the 1st optical power detector 87A caused by the position change and/or shape change of the spot. An actuator 91 moves the objective lens 10 in the direction of an optical axis based on this detection so that the light flux from the 1st laser diode 81A may form an image on the information recording surface MB of the 1st optical disc DB. And the actuator 91 moves the objective lens 10 in the direction perpendicular to an optic axis so that image formation of the light flux from this 1st laser diode 81A may be carried out on a predetermined track.

Next, when playing the 2nd optical disc DD or DC, laser light with a wavelength of 655 nm is emitted from the 2nd laser diode 81B and the emitted light flux turns into a parallel light flux by the collimator system 82B. The light flux passes through the grating 83B, the polarization beam splitter 84B, and ¼ wavelength plate 88B and then after passing through the dichroic prism 84C and the prism mirror 84D, the light flux is condensed on the information recording surface MD of the 2nd optical disc DD, or MC of the 2nd optical disc DD, by the objective lens 10.

The light flux which was modulated on the information recording surface MD or MC by the information bit and was reflected, passes through the objective lens 10 again and it enters into the polarization beam splitter 84B through the dichroic prism 84C etc. The light flux is reflected at the dichroic prism 84C and astigmatism is given by the servo lens 85B. The light flux then enters on the 1st optical power detector 87A, and the reading signal of the information recorded on the 2nd optical disc DD or DC is acquired using the output signal.

In addition, like the case of the 1st optical disc D13, focus detection and track detection are performed by detecting the change of the light volume of the spot on the 2nd optical power detector 87B caused by the position change and/or shape change of the spot and the objective lens 10 is moved for the focusing and the tracking.

In addition, although the above was explanation in the case of reproducing information from the optical disc DB and DD (or DC), it is also possible to record information on the optical disc DB and DD (or DC) by adjusting the output of the semiconductor lasers 81A and 81B etc.

Moreover, if the 2nd laser diode 81B is a two-wave type laser diode and the objective lens 10 is a three-wave compatible type, the optical pickup device can also be used as a three-wave compatible type optical pickup device.

Apparent from the above explanation, in the objective lens 10 of the present embodiment, the projection portion 14 provided in the flange part 12 covers the outermost circumference of the line shape FS from the outside in a direction perpendicular to an optical axis OA. Therefore, the cavity portion corresponding to the resin inlet side among the projection portion 14 prepared in the flange part is filled up with the resin introduced in the cavity CV formed in the mold at the time of injection molding at first, and then the cavity portion corresponding to the fine shape FS which adjoins the projection portion 14 is filled up with the resin introduced in the cavity. After filling up with the resin, the entire outermost circumference of the fine shape FS is surrounded by the projection portion 14.

Thus, the temperature fall of the mold surface portion S11 corresponding to this fine shape FS is controlled by heating beforehand the mold surface portion for transfer of fine shape FS in the mold with resin collected on the cavity corresponding to the projection portion 14. As a result, since the resin introduced into the mold surface portion corresponding to the fine shape (specifically, the recess R2) where it got warm by preheating among in the mold enters into the concave portion of the fine transfer structure of a mold surface portion which corresponds to the fine shape FS easily, the transferability can be improved and it can offer a highly precise optical element.

Although the present invention was explained based on the embodiment, present invention is not limited to the above-mentioned embodiment, and various modification is possible for it. For example, the shape of the cavity of a molding die CV established in the injection-molding die which is constituted of a fixed mold 42 and a movable mold 41 can be made not only into the shape of illustration but into various shape if the whole outermost circumference of the fine shape FS is surrounded by the projection portion 14. That is, the shape of the cavity of a molding die CV formed by the core dies 64a and 74a etc. is mere illustration, and can be suitably changed according to the use of objective lens 10 and other optical elements etc. In addition, the use of the objective lens 10 can also be made BD exclusive use not only in compatibility, for example. Moreover, the use of the objective lens 10 can also be used not only as optical pickup device but as the lens for an image pick-up etc.

Moreover, the shape of the projection portion 14 prepared in the flange part 12 of the objective lens 10 does not need to be symmetrical with the surroundings of optical axis OA, for example, thickness F of the projection portion 14 may change partially.

Fine shape FS formed in the optically functional part 11 of the objective lens 10 can also be made into various diffractive structures not only according to the shape of illustration but a shape accorded with use etc.

### REFERENCE SIGNS LIST

10 Objective lens
11 Optically functional part
12 Flange part
12a Top surface
13 Constricted portion
14 Projection portion
14a Bore surface
14b Outer surface
40 Molding die
41 Movable mold
42 Fixed mold
51 Mold open/close drive apparatus
52 Back-and-forth drive apparatus
61, 71 Template
63, 72 Attachment plate
64a, 74a Core die
68 Back-and forth member
81A, 81B Laser diode
84A, 84B Polarization beam splitter
84C Dichroic prism
87A, 87B light detector
91 Actuator
CV Cavity of a molding die
CV1 Main body cavity
CV2 Flange cavity
FC Flow channel space
FS Fine shape
GP Gate
I1 First intersection
I2 Second intersection
OA Optical axis
OS1, OS2 Optical surface
P Projection
Pa Peak
PS1, PS2 Parting surface
S1, S2 Transfer surface
S11 Mold surface portion

1. An optical element comprising: an optically functional part provided with a fine shape on an optical surface of the optical element; and a flange part provided on a periphery of the optically functional part, wherein the optical element is formed by injection molding of a resin introduced into a cavity of a molding die through a portion corresponding to an outer peripheral edge of the flange part,
wherein:
the flange part includes a heat insulation keep-warm part which projects in an optical surface side, and the heat insulation keep-warm part covers an outermost circumference of the fine shape provided on the optical surface from outside in a direction perpendicular to an optical axis.

2. The optical element of claim 1, wherein the heat insulation keep-warm part is provided circularly along the flange part.

3. The optical element of claim 1, wherein the flange part includes a constricted portion formed in a boundary with the optically functional part, and a ratio of A/B is 0.25 or more and 0.85 or less,
where A represents a distance in a direction of the optical axis from a bottom of the constricted portion to a distal end vertex of the fine shape that is covered by the heat insulation keep-warm part and B represents a distance in the direction of the optical axis from the bottom of the constricted portion to a top of the heat insulation keep-warm part.

4. The optical element of claim 2, wherein C and D satisfy a relationship of C<D, where C represents a distance from a distal end vertex of the outermost circumference of the fine shape that is covered by the heat insulation keep-warm part to a first intersection at which a line extending in a radial direction perpendicular to the optical axis intersects with a bore surface of the heat insulation keep-warm part and D represents a distance from the first intersection to a second intersection at which the line extending in a radial direction perpendicular to the optical axis interests with an outer surface of the heat insulation keep-warm part.

5. The optical element of claim 2, wherein D and E satisfy a relationship of E<D, where D represents a distance from a first intersection at which a line extending in a radial direction perpendicular to an optical axis intersects with a bore surface of the heat insulation keep-warm part from a distal end vertex of the fine shape that is covered by the heat insulation keep-warm part to a second intersection at which the line interests with an outer surface of the heat insulation keep-warm part and E represents a thickness in a direction of the optical axis of a constricted portion of the flange part formed in a boundary with the optically functional part.

6. The optical element of claim 5, wherein a ratio E/D is 0.65 or more and 0.85 or less.

7. The optical element of claim 1, wherein an angle θ between a bore surface of the heat insulation keep-warm part and an optical axis is 5° or more and 45° or less.

8. The optical element of claim 2, wherein an angle θ between a bore surface of the heat insulation keep-warm part and an optical axis is 5° or more and 45° or less

9. The optical element of claim 3, wherein an angle θ between a bore surface of the heat insulation keep-warm part and an optical axis is 5° or more and 45° or less

10. The optical element of claim 4, wherein an angle θ between a bore surface of the heat insulation keep-warm part and an optical axis is 5° or more and 45° or less

11. The optical element of claim 5, wherein an angle θ between a bore surface of the heat insulation keep-warm part and an optical axis is 5° or more and 45° or less

12. The optical element of claim 6, wherein an angle θ between a bore surface of the heat insulation keep-warm part and an optical axis is 5° or more and 45° or less
